(19) United States
(12) Patent Application Publication
(10) Pub. No.: US 2026/0320289 A1
(43) Pub. Date: Oct. 15, 2026

(54) FIELD OPERATIONS FRAMEWORK

(71) Applicant: Schlumberger Technology Corporation, Sugar Land, TX (US)

(72) Inventors: Pradeep Kumar Shetty, Houston, TX (US); Antonio Massoni Abinader, Houston, TX (US); Oleg O. Medvedev, Houston, TX (US); Chunling Gu Coffman, Houston, TX (US); Matthew Worthington, Houston, TX (US); Nasser Ghorbani, Houston, TX (US)

(21) Appl. No.: 19/176,941

(22) Filed: Apr. 11, 2025

(51) Int. Cl. G06F 40/186; G06F 40/109

(52) U.S. Cl. CPC G06F 40/186; G06F 40/109

(57) ABSTRACT

A method can include receiving real-time data from field equipment at a field site; responsive to receipt of the real-time data, dynamically generating instructions for a user interface for field operations at the field site; transmitting the instructions via a network to a display device for rendering of the user interface to a display of the display device; receiving interaction data responsive to interactions with the display device; responsive to receipt one or more of the interaction data and additional real-time data from the field equipment, dynamically generating revised instructions for a revised user interface for field operations at the field site; and transmitting the revised instructions via the network to the display device for rendering of the revised user interface to the display of the display device.

### BACKGROUND

Field operations can be performed at a field site that include field equipment. Such field operations may demand monitoring. As such, a framework may provide for rendering of a fixed graphical user interface that allows a user to view graphics to monitor the field operations. A fixed graphical user interface can come with downsides, which may result in sub-optimal monitoring.

### SUMMARY

A method can include receiving real-time data from field equipment at a field site; responsive to receipt of the real-time data, dynamically generating instructions for a user interface for field operations at the field site; transmitting the instructions via a network to a display device for rendering of the user interface to a display of the display device; receiving interaction data responsive to interactions with the display device; responsive to receipt one or more of the interaction data and additional real-time data from the field equipment, dynamically generating revised instructions for a revised user interface for field operations at the field site; and transmitting the revised instructions via the network to the display device for rendering of the revised user interface to the display of the display device. A system can include a processor; a memory operatively coupled to the processor; and processor-executable instructions stored in the memory and executable to instruct the system to: receive real-time data from field equipment at a field site; responsive to receipt of the real-time data, dynamically generate instructions for a user interface for field operations at the field site; transmit the instructions via a network to a display device for rendering of the user interface to a display of the display device; receive interaction data responsive to interactions with the display device; responsive to receipt one or more of the interaction data and additional real-time data from the field equipment, dynamically generate revised instructions for a revised user interface for field operations at the field site; and transmit the revised instructions via the network to the display device for rendering of the revised user interface to the display of the display device. One or more computer-readable storage media can include processor-executable instructions executable by a system to instruct the system to: receive real-time data from field equipment at a field site; responsive to receipt of the real-time data, dynamically generate instructions for a user interface for field operations at the field site; transmit the instructions via a network to a display device for rendering of the user interface to a display of the display device; receive interaction data responsive to interactions with the display device; responsive to receipt one or more of the interaction data and additional real-time data from the field equipment, dynamically generate revised instructions for a revised user interface for field operations at the field site; and transmit the revised instructions via the network to the display device for rendering of the revised user interface to the display of the display device. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a geological environment;

FIG. 2 illustrates an example of a system for implementing various workflows;

FIG. 3 illustrates an example of an environment and an example of a system;

FIG. 4 illustrates examples of components;

FIG. 5 illustrates an example of a system;

FIG. 6 illustrates an example of a system;

FIG. 7 illustrates an example of a system;

FIG. 8 illustrates an example of a method, according to an embodiment, and an example of a system, according to an embodiment; and

FIG. 9 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

Below, various types of environments, frameworks, workflows, data acquisition techniques, field equipment, field operations, etc., are described, which may involve use of a framework or frameworks, optionally during one or more field operations.

### Example System Including Workspace Framework

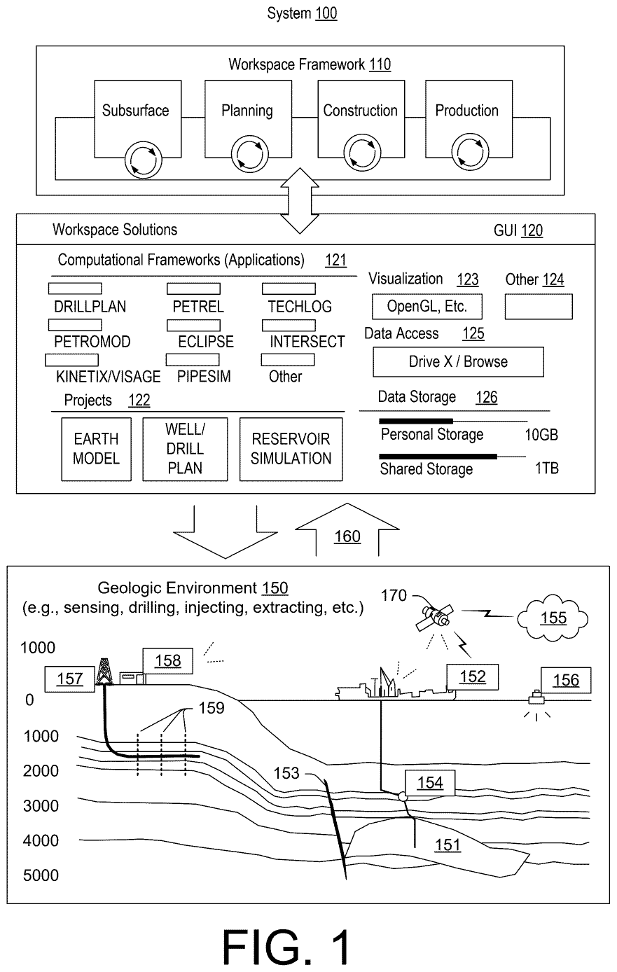

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. A geologic environment 150 may be outfitted with a variety of sensors, detectors, actuators, etc. In such an environment, various types of equipment such as, for example, equipment 152 may include communication circuitry to receive and to transmit information, optionally with respect to one or more networks 155. Such information may include information associated with downhole equipment 154, which may be equipment to acquire information, to assist with resource recovery, etc. Other equipment 156 may be located remote from a wellsite and include sensing, detecting, emitting, or other circuitry. Such equipment may include storage and communication circuitry to store and to communicate data, instructions, etc. One or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc., may exist where an assessment of such variations may assist with planning, operations, etc., to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, INTERSECT, KINETIX/VISAGE, and PIPESIM frameworks (SLB, Houston, Texas). One or more types of frameworks may be implemented within or in a manner operatively coupled to the DELFI environment, which is a secure, cognitive, cloud-based collaborative environment that integrates data and workflows with digital technologies, such as artificial intelligence (AI) and machine learning (ML). Such an environment can provide for operations that involve one or more frameworks. The DELFI environment may be referred to as the DELFI framework, which may be a framework of frameworks. The DELFI environment can include various other frameworks, which may operate using one or more types of models (e.g., simulation models, etc.).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The DRILLOPS framework, which may be included in the system 100 of FIG. 1, may execute a digital drilling plan and ensures plan adherence, while delivering goal-based automation. The DRILLOPS framework may generate activity plans automatically individual operations, whether they are monitored and/or controlled on the rig or in town. Automation may utilize data analysis and learning systems to assist and optimize tasks, such as, for example, setting ROP to drilling a stand. A preset menu of automatable drilling tasks may be rendered, and, using data analysis and models, a plan may be executed in a manner to achieve a specified goal, where, for example, measurements may be utilized for calibration. The DRILLOPS framework provides flexibility to modify and replan activities dynamically, for example, based on a live appraisal of various factors (e.g., equipment, personnel, and supplies). Well construction activities (e.g., tripping, drilling, cementing, etc.) may be continually monitored and dynamically updated using feedback from operational activities. The DRILLOPS framework may provide for various levels of automation based on planning and/or re-planning (e.g., via the DRILLPLAN framework), feedback, etc.

The PETREL framework can be part of the DELFI cognitive exploration and production (E&P) environment (SLB, Houston, Texas, referred to as the DELFI environment) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc. As an example, the TECHLOG framework may be coupled to one or more ML models for purposes of generation of output, training, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator with numerical solvers for prediction of dynamic behavior for various types of reservoirs and development schemes.

The INTERSECT framework provides a high-resolution reservoir simulator for simulation of geological features and quantification of uncertainties, for example, by creating production scenarios and, with the integration of precise models of the surface facilities and field operations, the INTERSECT framework can produce results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases.

The KINETIX framework provides for reservoir-centric stimulation-to-production analyses that can integrate geology, petrophysics, completion engineering, reservoir engineering, and geomechanics, for example, to provide for optimized completion and fracturing designs for a well, a pad, or a field. The KINETIX framework can be operatively coupled to and/or integrated with features of the PETREL framework (e.g., within the DELFI environment). As to the VISAGE framework it can be part of or otherwise operatively coupled to the KINETIX framework.

The VISAGE framework includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO2 disposal, etc.

As an example, the KINETIX framework can provide for analyses from 1D logs and simple geometric completions to 3D mechanical and petrophysical models coupled with the INTERSECT framework high-resolution reservoir simulator and VISAGE framework finite-element geomechanics simulator. The KINETIX framework can provide automated parallel processing using cloud platform resources and can provide for rapid assessment of well spacing, completion, and treatment design choices, enabling exploration of many scenarios in a relatively rapid manner (e.g., via provisioning of cloud platform resources). The KINETIX framework may be operatively coupled to the MANGROVE simulator (SLB, Houston, Texas), which can provide for optimization of stimulation design (e.g., stimulation treatment operations such as hydraulic fracturing) in a reservoir-centric environment.

The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). The PIPESIM simulator may be an optimizer that can optimize one or more operational scenarios at least in part via simulation of physical phenomena.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150, and feedback 160 can be received via one or more interfaces in one or more forms (e.g., acquired data as to operational conditions, equipment conditions, environment conditions, etc.).

As an example, a platform, such as, for example, the LUMI platform (SLB, Houston, Texas) may be utilized. The LUMI platform includes features that provide for artificial intelligence solutions as may be integrated with data management capabilities. The LUMI platform provides for flexible deployment options and an open, secure, and modular architecture, for example, to empower data-driven decision-making. The LUMI platform is operable with the DELFI environment and, hence, one or more of various frameworks. While various platforms, environments, frameworks, libraries, etc., are mentioned, a framework may be operable in an agnostic manner, for example, to be compatible with one or more other platforms, environments, frameworks, libraries, technologies, etc.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

Visualization features may provide for visualization of various earth models, properties, etc., in one or more dimensions. As an example, visualization features may include one or more control features for control of equipment, which can include, for example, field equipment that can perform one or more field operations. A workflow may utilize one or more frameworks to generate information that can be utilized to control one or more types of field equipment (e.g., drilling equipment, wireline equipment, fracturing equipment, etc.).

### Example System for Workflow Implementations

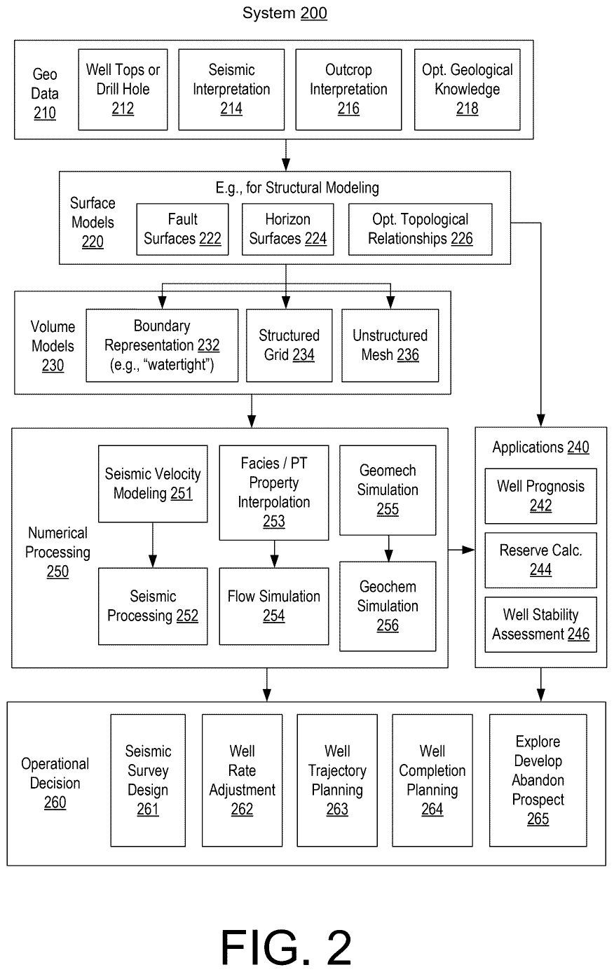

FIG. 2 shows an example of a system 200 that can be operatively coupled to one or more databases, data streams, etc. For example, one or more pieces of field equipment, laboratory equipment, computing equipment (e.g., local and/or remote), etc., can provide and/or generate data that may be utilized in the system 200.

As shown, the system 200 can include a geological/geophysical data block 210, a surface models block 220 (e.g., for one or more structural models), a volume modules block 230, an applications block 240, a numerical processing block 250 and an operational decision block 260. As shown in the example of FIG. 2, the geological/geophysical data block 210 can include data from well tops or drill holes 212, data from seismic interpretation 214, data from outcrop interpretation and optionally data from geological knowledge. As an example, the geological/geophysical data block 210 can include data from digital images, which can include digital images of cores, cuttings, cavings, outcrops, etc. As to the surface models block 220, it may provide for creation, editing, etc. of one or more surface models based on, for example, one or more of fault surfaces 222, horizon surfaces 224 and optionally topological relationships 226. As to the volume models block 230, it may provide for creation, editing, etc. of one or more volume models based on, for example, one or more of boundary representations 232 (e.g., to form a watertight model), structured grids 234 and unstructured meshes 236.

As shown in the example of FIG. 2, the system 200 may allow for implementing one or more workflows, for example, where data of the data block 210 are used to create, edit, etc. one or more surface models of the surface models block 220, which may be used to create, edit, etc. one or more volume models of the volume models block 230. As indicated in the example of FIG. 2, the surface models block 220 may provide one or more structural models, which may be input to the applications block 240. For example, such a structural model may be provided to one or more applications, optionally without performing one or more processes of the volume models block 230 (e.g., for purposes of numerical processing by the numerical processing block 250). Accordingly, the system 200 may be suitable for one or more workflows for structural modeling (e.g., optionally without performing numerical processing per the numerical processing block 250).

As to the applications block 240, it may include applications such as a well prognosis application 242, a reserve calculation application 244 and a well stability assessment application 246. As to the numerical processing block 250, it may include a process for seismic velocity modeling 251 followed by seismic processing 252, a process for facies and petrophysical property interpolation 253 followed by flow simulation 254, and a process for geomechanical simulation 255 followed by geochemical simulation 256. As indicated, as an example, a workflow may proceed from the volume models block 230 to the numerical processing block 250 and then to the applications block 240 and/or to the operational decision block 260. As another example, a workflow may proceed from the surface models block 220 to the applications block 240 and then to the operational decisions block 260 (e.g., consider an application that operates using a structural model).

In the example of FIG. 2, the operational decisions block 260 may include a seismic survey design process 261, a well rate adjustment process 252, a well trajectory planning process 263, a well completion planning process 264 and a process for one or more prospects, for example, to decide whether to explore, develop, abandon, etc. a prospect.

Referring again to the data block 210, the well tops or drill hole data 212 may include spatial localization, and optionally surface dip, of an interface between two geological formations or of a subsurface discontinuity such as a geological fault; the seismic interpretation data 214 may include a set of points, lines or surface patches interpreted from seismic reflection data, and representing interfaces between media (e.g., geological formations in which seismic wave velocity differs) or subsurface discontinuities; the outcrop interpretation data 216 may include a set of lines or points, optionally associated with measured dip, representing boundaries between geological formations or geological faults, as interpreted on the earth surface; and the geological knowledge data 218 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g., fault A truncates fault B, fault B intersects fault C, etc.).

As to the one or more boundary representations 232, they may include a numerical representation in which a subsurface model is partitioned into various closed units representing geological layers and fault blocks where an individual unit may be defined by its boundary and, optionally, by a set of internal boundaries such as fault surfaces.

As to the one or more structured grids 234, it may include a grid that partitions a volume of interest into different elementary volumes (cells), for example, that may be indexed according to a pre-defined, repeating pattern. As to the one or more unstructured meshes 236, it may include a mesh that partitions a volume of interest into different elementary volumes, for example, that may not be readily indexed following a pre-defined, repeating pattern (e.g., consider a Cartesian cube with indexes I, J, and K, along x, y, and z axes).

As to the seismic velocity modeling 251, it may include calculation of velocity of propagation of seismic waves (e.g., where seismic velocity depends on type of seismic wave and on direction of propagation of the wave). As to the seismic processing 252, it may include a set of processes allowing identification of localization of seismic reflectors in space, physical characteristics of the rocks in between these reflectors, etc.

As to the facies and petrophysical property interpolation 253, it may include an assessment of type of rocks and of their petrophysical properties (e.g., porosity, permeability), for example, optionally in areas not sampled by well logs or coring. As an example, such an interpolation may be constrained by interpretations from log and core data, and by prior geological knowledge.

As to the flow simulation 254, as an example, it may include simulation of flow of hydro-carbons in the subsurface, for example, through geological times (e.g., in the context of petroleum systems modeling, when trying to predict the presence and quality of oil in an un-drilled formation) or during the exploitation of a hydrocarbon reservoir (e.g., when some fluids are pumped from or into the reservoir).

As to geomechanical simulation 255, it may include simulation of the deformation of rocks under boundary conditions. Such a simulation may be used, for example, to assess compaction of a reservoir (e.g., associated with its depletion, when hydrocarbons are pumped from the porous and deformable rock that composes the reservoir). As an example, a geomechanical simulation may be used for a variety of purposes such as, for example, prediction of fracturing, reconstruction of the paleo-geometries of the reservoir as they were prior to tectonic deformations, etc.

As to geochemical simulation 256, such a simulation may simulate evolution of hydrocarbon formation and composition through geological history (e.g., to assess the likelihood of oil accumulation in a particular subterranean formation while exploring new prospects).

As to the various applications of the applications block 240, the well prognosis application 242 may include predicting type and characteristics of geological formations that may be encountered by a drill bit, and location where such rocks may be encountered (e.g., before a well is drilled); the reserve calculations application 244 may include assessing total amount of hydrocarbons or ore material present in a subsurface environment (e.g., and estimates of which proportion can be recovered, given a set of economic and technical constraints); and the well stability assessment application 246 may include estimating risk that a well, already drilled or to-be-drilled, will collapse or be damaged due underground stress.

As to the operational decision block 260, the seismic survey design process 261 may include deciding where to place seismic sources and receivers to optimize the coverage and quality of the collected seismic information while minimizing cost of acquisition; the well rate adjustment process 262 may include controlling injection and production well schedules and rates (e.g., to maximize recovery and production); the well trajectory planning process 263 may include designing a well trajectory to maximize potential recovery and production while minimizing drilling risks and costs; the well trajectory planning process 264 may include selecting proper well tubing, casing and completion (e.g., to meet expected production or injection targets in specified reservoir formations); and the prospect process 265 may include decision making, in an exploration context, to continue exploring, start producing or abandon prospects (e.g., based on an integrated assessment of technical and financial risks against expected benefits).

The system 200 can include and/or can be operatively coupled to a system such as the system 100 of FIG. 1. For example, the workspace framework 110 may provide for instantiation of, rendering of, interactions with, etc., the graphical user interface (GUI) 120 to perform one or more actions as to the system 200. In such an example, access may be provided to one or more frameworks (e.g., DRILLPLAN, DRILLOPS, PETREL, TECHLOG, PETROMOD, ECLIPSE, INTERSECT, KINETIX/VISAGE, PIPESIM, etc.). One or more frameworks may provide for geo data acquisition as in block 210, for structural modeling as in block 220, for volume modeling as in block 230, for running an application as in block 240, for numerical processing as in block 250, for operational decision making as in block 260, etc.

As an example, the system 200 may provide for monitoring data, which can include geo data per the geo data block 210. In various examples, geo data may be acquired during one or more operations. For example, consider acquiring geo data during drilling operations via downhole equipment and/or surface equipment. As an example, the operational decision block 260 can include capabilities for monitoring, analyzing, etc., such data for purposes of making one or more operational decisions, which may include controlling equipment, revising operations, revising a plan, etc. In such an example, data may be fed into the system 200 at one or more points where the quality of the data may be of particular interest. For example, data quality may be characterized by one or more metrics where data quality may provide indications as to trust, probabilities, etc., which may be germane to operational decision making and/or other decision making. As an example, the system 200 of FIG. 2 may include one or more ML models, for example, consider one or more ML models for use in one or more types of hydraulic fracturing workflows.

### Examples of Geologic Environments and Systems

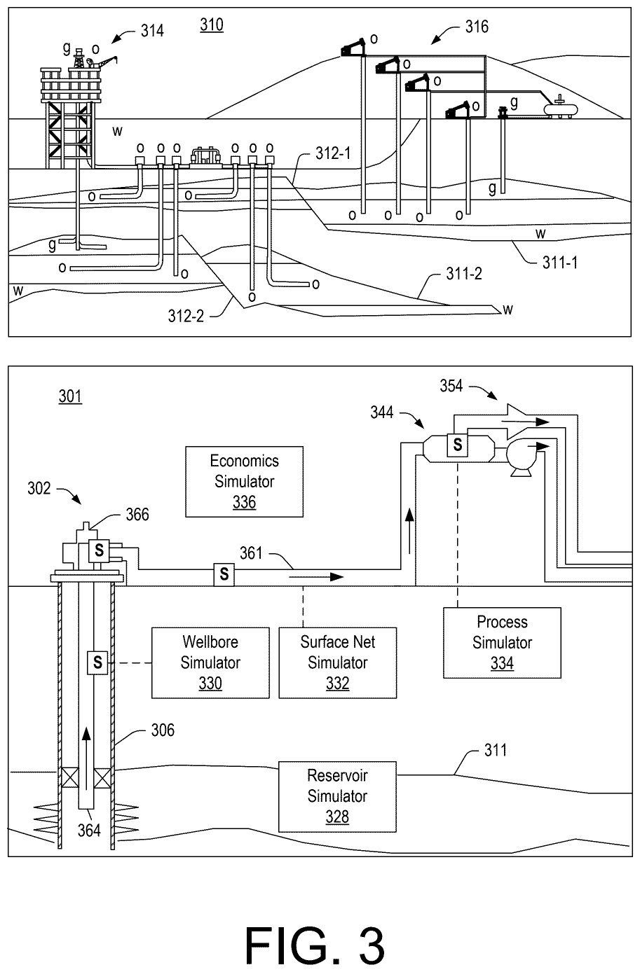

FIG. 3 shows an example of portion of a geologic environment 301 and an example of a larger portion of a geologic environment 310. As shown, a geologic environment can include one or more reservoirs 311-1 and 311-2, which may be faulted by faults 312-1 and 312-2 and which may include oil (o), gas (g) and/or water (w). FIG. 3 also shows some examples of offshore equipment 314 for oil and gas operations related to the reservoirs 311-1 and 311-2 and onshore equipment 316 for oil and gas operations related to the reservoir 311-1. As an example, a system may be implemented for operations associated with one or more of such reservoirs.

As to the geologic environment 301, FIG. 3 shows a schematic view where the geologic environment 301 can include various types of equipment. As shown in FIG. 3, the environment 301 can includes a wellsite 302 and a fluid network 344. In the example of FIG. 3, the wellsite 302 includes a wellbore 306 extending into earth as completed and prepared for production of fluid from a reservoir 311 (e.g., one of the reservoirs 311-1 or 311-2).

In the example of FIG. 3, wellbore production equipment 364 extends from a wellhead 366 of the wellsite 302 and to the reservoir 311 to draw fluid to the surface. As shown, the wellsite 302 is operatively connected to the fluid network 344 via a transport line 361. As indicated by various arrows, fluid can flow from the reservoir 311, through the wellbore 306 and onto the fluid network 344. Fluid can then flow from the fluid network 344, for example, to one or more fluid processing facilities.

In the example of FIG. 3, sensors(S) are located, for example, to monitor various parameters during operations. The sensors(S) may measure, for example, pressure, temperature, flowrate, composition, and other parameters of the reservoir, wellbore, gathering network, process facilities and/or other portions of an operation. As an example, the sensors(S) may be operatively connected to a surface unit (e.g., to instruct the sensors to acquire data, to collect data from the sensors, etc.).

In the example of FIG. 3, a surface unit can include computer facilities, such as a memory device, a controller, one or more processors, and a display unit (e.g., for managing data, visualizing results of an analysis, etc.). As an example, data may be collected in the memory device and processed by the processor(s) (e.g., for analysis, etc.). As an example, data may be collected from the sensors(S) and/or by one or more other sources. For example, data may be supplemented by historical data collected from other operations, user inputs, etc. As an example, analyzed data may be used to in a decision-making process.

As an example, a transceiver may be provided to allow communications between a surface unit and one or more pieces of equipment in the environment 301. For example, a controller may be used to actuate mechanisms in the environment 301 via the transceiver, optionally based on one or more decisions of a decision-making process. In such a manner, equipment in the environment 301 may be selectively adjusted based at least in part on collected data. Such adjustments may be made, for example, automatically based on computer protocol, manually by an operator or both. As an example, one or more well plans may be adjusted (e.g., to select optimum operating conditions, to avoid problems, etc.).

To facilitate data analyses, one or more simulators may be implemented (e.g., optionally via the surface unit or other unit, system, etc.). As an example, data fed into one or more simulators may be historical data, real time data or combinations thereof. As an example, simulation through one or more simulators may be repeated or adjusted based on the data received.

In the example of FIG. 3, simulators can include a reservoir simulator 328, a wellbore simulator 330, a surface network simulator 332, a process simulator 334 and an economics simulator 336. As an example, the reservoir simulator 328 may be configured to solve for hydrocarbon flow rate through a reservoir and into one or more wellbores. As an example, the wellbore simulator 330 and surface network simulator 332 may be configured to solve for hydrocarbon flow rate through a wellbore and a surface gathering network of pipelines. As to the process simulator 334, it may be configured to model a processing plant where fluid containing hydrocarbons is separated into its constituent components (e.g., methane, ethane, propane, etc.), for example, and prepared for further distribution (e.g., transport via road, rail, pipe, etc.) and optionally sale. As an example, the economics simulator 336 may be configured to model costs associated with at least part of an operation. For example, consider MERAK framework (SLB, Houston, Texas), which may provide for economic analyses.

As an example, a system can include and/or be operatively coupled to one or more of the simulators 328, 330, 332, 334 and 336 of FIG. 3. As an example, such simulators may be associated with frameworks and/or may be considered tools (see, e.g., the system 100 of FIG. 1, etc.). Various pieces of equipment in the example geologic environments 301 and 310 of FIG. 3 may be operatively coupled to one or more systems, one or more frameworks, etc. As an example, one or more of the sensors(S) may be operatively coupled to one or more networks (e.g., wired and/or wireless) for transmission of data, which, as explained, may include data indicative of production. As shown, a sensor(S) may be utilized for acquisition of downhole data and/or surface data, which can include data relevant to production (e.g., flow rate, temperature, pressure, composition, etc.). Such data may be utilized in a system such as, for example, the system 100 of FIG. 1 for operational decision-making, etc.

While various examples of field equipment are illustrated for hydrocarbon related production operations, as explained, field equipment may be for one or more other types of operations where such field equipment can acquire data (e.g., field equipment data) that can be utilized for operation decision making and/or one or more other purposes. As explained, field equipment data may be suitable for use with one or more frameworks, one or more workflows, etc. Uses of field equipment data can involve transfers such as, for example, inter-framework transfers where one or more types of data related issues may arise due to formatting, unit conversions, coordinate reference system (CRS) conversions, etc. Use of field equipment data can be enhanced through automated or semi-automated processes that can perform tasks such as identifying data (e.g., data types, etc.) and/or assessing quality of data.

As explained, various types of frameworks may be utilized in one or more phases, stages, etc., of field operations. Such frameworks may be part of a unified platform or computational environment or may be compatible with such a platform or computational environment. As an example, a platform or computational environment may be extensible to provide for operative coupling to various frameworks, which may include native and non-native frameworks. In various instances, a homogenous approach may be implemented while in various other instances a heterogeneous approach may be implemented. As an example, a generative AI-powered intelligent UI/UX design platform may provide for leveraging, coordinating, etc., utilization of framework features for field operations. In such an example, such a generative, AI-based platform (GAIP) may provide for improved field operations, particularly in the industries that involve subsurface assets and associated surface facilities. For example, a subsurface asset may be a reservoir and associated surface facilities may include conduits and other equipment suitable for production of fluid from the reservoir and/or injection of fluid from the reservoir (see, e.g., FIG. 1 and FIG. 3).

Considering the oil and gas industry as an example, operations occur in or with respect to a relatively complex environment that demands specialized tools for data visualization, monitoring, decision-making, control, etc. As an example, a GAIP may provide for improving user interactions with digital interfaces, where a user may be a human and/or a machine. For example, a GAIP may be tailored specifically for implementation in the oil and gas sector. In such an example, tailoring may be achieved at least in part through machine learning, which may target one or more domains within the oil and gas industry, noting that gas may refer to one or more types of greenhouse gas (GHG) technologies (e.g., carbon capture and sequestration, etc.).

As an example, a GAIP may leverage advanced artificial intelligence technologies and techniques to create, adapt, and optimize various user interfaces dynamically, enhancing productivity, and facilitating better decision-making across various roles within an industry. Such a GAIP may provide an advancement in how professionals in the oil and gas industry interact with data and digital tools. For example, by combining advanced AI capabilities with industry-specific requirements, a GAIP can offer a customizable, efficient, and intelligent platform that addresses various challenges that may be specific to an industry sector. As an example, a GAIP may provide for features such as one or more of AI powered template accelerators, collaboration tools, industrial canvases, XR support, and enhanced collaboration tools. In such an example, a GAIP may provide a relatively comprehensive solution to transform industry practices.

### Example Components

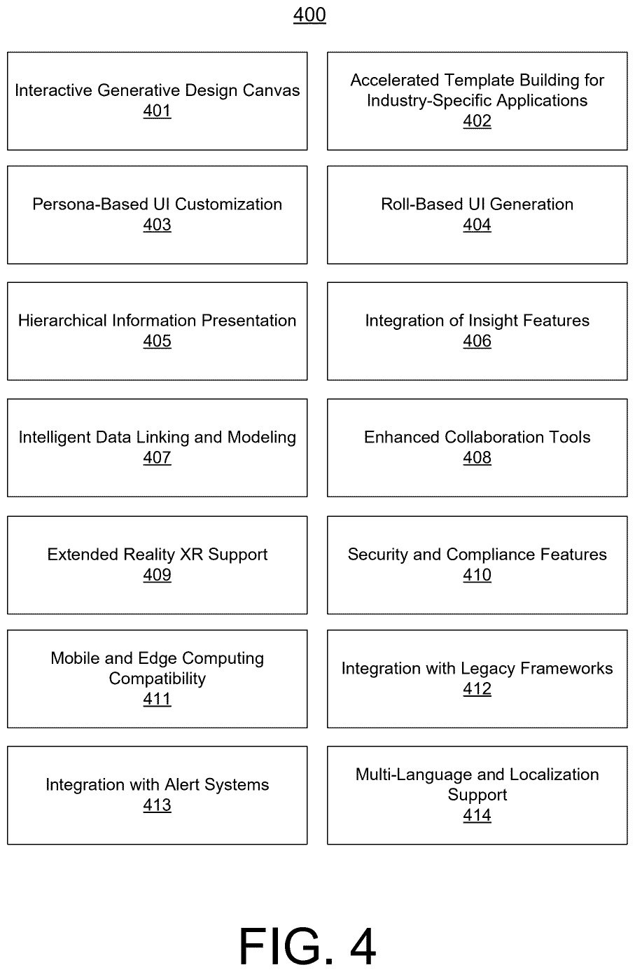

FIG. 4 shows some examples of components 400 that may be part of a GAIP. As shown, an interactive generative design canvas component 401 may be included, which may provide support for one or more of: natural language interaction such that users can request the generation of charts, tables, and other visual elements through conversational language; real-time refinement for on-the-fly modifications such as color changes, style adjustments, and data parameter tweaks; domain-specific templates utilization to incorporates industry-standard templates like production monitoring dashboards and decline curve analyses; industrial canvas concepts to act as a digital workspace where users can design and manipulate UI elements interactively; multi-user collaboration to allow multiple users to work together on the same canvas, facilitating teamwork and enhancing design efficiency; component library integration to provides a library of reusable components specific to, for example, the oil and gas industry, such as gauges, flow diagrams, and process schematics, allowing users to quickly assemble complex UIs; scenario-based design mode implementation to enable users to create and visualize different operational scenarios, helping in planning and decision-making; customizable workflow automation for automation of repetitive tasks within a canvas, such as, for example, generating recurring reports or setting up specific dashboard configurations; and visual scripting interface implementation that may offers a no-code/low-code environment where users can visually script interactions and data bindings between UI elements, reducing demands for extensive programming knowledge.

As shown, an accelerated template building component 402 for industry-specific applications may be included, which may provide support for one or more of: sketch-to-UI conversion to transform hand-drawn sketches into functional UI code, expediting the development process; screenshot interpretation to analyze existing screenshots to replicate and enhance UI templates; template repository expansion that may continuously learn and/or add new templates based on user input and industry trends; industry-specific template customization to allow for customization of templates to fit specific operational demands within different field-related processes; AI-driven template suggestions that may implement AI features to recommend relevant templates based on a user's current project and/or historical usage; rapid prototyping tools that provide for quickly creating prototypes from templates, allowing for faster validation and iteration; and template performance analytics that can track how templates are utilized and to perform analytics to identify most effective templates for specific use cases and/or least effective templates, which may be utilized subject to various warnings or notifications as to restrictions, specific concerns, etc.

As shown, a persona-based UI customization component 403 may be included, which may provide support for one or more of: user behavior analysis (UI) to monitor how different types of users interact with a UI for specific tasks, helping understand their desires and preferences; user behavior analysis (e.g., generative AI prompt engineering, etc.) to monitor different user prompts, for example, to determine trends and repetitive information lookup and/or automatic generation of user selectable prompts that may optionally be modified revised, etc. and/or that may be presented in a sequence (e.g., as a list, etc.) to provide insight as to actions or possible actions for a workflow or workflows; adaptive interface generation that may build personalized user interfaces based on each role or roles of one or more users, preferences, past activities, etc., which may facilitate completion of a work task, a workflow, etc., which may aim to provide for adherence to one or more procedures (e.g., consider one or more standard operating procedures (SOPs), etc.); and efficiency enhancement that may make workflows smoother, for example, by showing user tools and information that are most relevant to thereby help to reduce time spent searching for resources.

As shown, a role-based UI customization component 404 may be included, which may provide support for one or more of: collaborative usage monitoring, for example, to digitally observe how people in the same job role use features across a company, a plant, etc.; standardized role interfaces for development of one or more UIs that may be optimized for specific roles, etc., to help ensure consistency and efficiency; and knowledge sharing facilitation, for example, to help users that may be unfamiliar with one or more aspects of a framework, a workflow, etc., to acclimate faster by providing interfaces aligned with role best practices.

As shown, a hierarchical information presentation component 405 may be included, which may provide support for one or more of: critical information relay that may aggregate and present vital data from ground-level operations to management tiers; dynamic reporting dashboards that generates high-level performance indexes and/or summaries for higher level personnel; decision support that provides actionable insights derived from operational data to aid strategic planning; and emergency alert system integration that may provide for detection of one or more types of emergencies and transmission of notifications, alerts, control signals, etc., to addresses, which may be for humans and/or machines, which may help to assure timely intervention.

As shown, an integration of insight features component 406 may be included, which may provide support for one or more of: user engagement metrics for tracking how individuals interact with one or more operational dashboards and tools to suggest productivity improvements; wellness indicators to monitors workload for individuals and/or other resources, for example, consider an approach that can monitor field engineers and control room operators to suggest adjustments that help prevent fatigue and burnout; collaboration insights for identification of opportunities for collaboration between different individuals, teams, departments, etc., such as, for example, drilling, production, and maintenance, based on usage data; focus time recommendations for analysis of work schedules to recommend optimal times for uninterrupted focus, especially for roles that require deep analysis like reservoir engineers; meeting effectiveness insights that provide for evaluation of effectiveness of safety and operational meetings, participation, and outcomes, providing suggestions for more efficient use of meeting times; workload balance monitoring that can identify workload distribution issues among field personnel and suggests ways to balance tasks to avoid overburdening key roles; and employee sentiment analysis that may utilize AI techniques, technologies, etc., to assess interactions and provide insights into morale and satisfaction levels of field teams and office staff.

As shown, an intelligent data linking and modeling component 407 may be included, which may provide support for one or more of: automated data binding that may, for example, connect various UI elements to data sources intelligently based on one or more underlying data models; data consistency checks that may help to ensures that visualizations are accurate and up-to-date with the latest data; scalable data handling for managing relatively large datasets, as may be present in the oil and gas industry (e.g., consider seismic data sets that may be terabytes in size, etc.); real-time data integration that integrates real-time data streams from sensors and field equipment to provide up-to-date visualizations and insights; advanced data correlations that provide for identification of relationships between different data sets, such as production metrics and equipment performance, to uncover actionable insights; context-aware data linking that automatically recognizes context of a data point and links it to one or more related datasets, which may help to provide a holistic view of operations and allow for data integration and contextualization, which may facilitate one or more types of machine learning processes and/or machine learning model use cases, etc.; and intelligent data recommendations that can suggests relevant data sources to users, for example, based on a current task, improving speed of analysis, reducing manual effort, etc.

As shown, an enhanced collaborative tools component 408 may be included, which may provide support for one or more of: real-time co-editing that allows multiple users to work on a common UI design simultaneously; version control and history that can maintain records of changes for accountability and rollback if appropriate; and feedback integration that may enable users to leave comments and suggestions directly within the UI design, where such feedback may be utilized in labeling, training, re-training, etc., one or more machine learning models.

As shown, an extended reality (XR) support component 409 may be included, which may provide support for one or more of: augmented reality (AR) interfaces that may provide for projection of data visualizations onto physical equipment for intuitive understanding; virtual reality (VR) environments to create immersive training modules and simulations for complex operations; and mixed reality applications that may provide for blending digital and physical worlds to enhance situational awareness.

As shown, a security and compliance features component 410 may be included, which may provide support for one or more of: role-based access control that helps to ensures users see information pertinent to their role and authorization level (e.g., in a focused manner that may help to reduce information overload, clutter, etc.); audit trails that may provide for registering detailed logs of user interactions for compliance and monitoring purposes, which may also provide for labeling, training, re-training, etc., one or more machine learning models; data encryption to help protect sensitive information both at rest and in transit; and blockchain generation, management, access, etc., that may provide for utilization of one or more blockchain techniques, technologies, etc., as to actions taken, data accessed, permissions utilized, logins performed (e.g., attempted, failed, successful, etc.), geolocation, equipment utilization, etc.

As shown, a mobile and edge computing compatibility component 411 may be included, which may provide support for one or more of: responsive design that can adapt one or more UIs for optimal viewing on various devices, including tablets and smartphones, which may include considerations as to human-machine interface (HMI) constraints, finger size (e.g., gloves or no gloves), lighting of an environment, language to display, etc.; offline functionality that allows for particular features to operate without constant network (e.g., Internet, etc.) connectivity, which may be relatively crucial for remote field operations (e.g., consider locations where satellite communication may be relied upon and dependent on weather, time of day, sunspot activity, radiation, etc.); and edge processing that can provide for utilization of one or more local computing resources to reduce latency and dependence on central servers.

As shown, an integration with legacy frameworks component 412 may be included, which may provide support for one or more of: application programming interface (API) support that may facilitate communication with existing frameworks, addons, plug-in, remote and/or local resources, databases, controllers, etc.; data migration tools that may help in transferring data from a legacy system into a GAIP; and custom connectors that may provide for building interfaces for one or more types of proprietary frameworks, systems, etc., as may be relatively common in the oil and gas industry.

As shown, an integration with alert systems component 413 may be included, which may provide support for one or more of: multi-channel alerts that provide notifications through one or more of various channels, which may include one or more of email, SMS, WhatsApp, and Microsoft Teams, to ensure timely communication; custom alert triggers that allows users to set custom triggers for alerts based on specific conditions, such as equipment failures or threshold breaches; priority-based alerts that may categorizes alerts based on their urgency, ensuring that critical alerts reach management immediately while less urgent ones are communicated accordingly; acknowledge and escalate mechanism that enables recipients to acknowledge alerts, and if no action is taken, escalates the alert to higher management; and alert analytics that can track alert responses and effectiveness, providing insights into response times and areas for improvement.

As shown, a multi-language and localization support component 414 may be included, which may provide support for one or more of: global usability that can support multiple languages to cater to international teams; cultural customization that may adapts UI elements to align with regional practices and standards; and regulatory compliance that may adjusts features to meet local laws and industry regulations.

### Example System

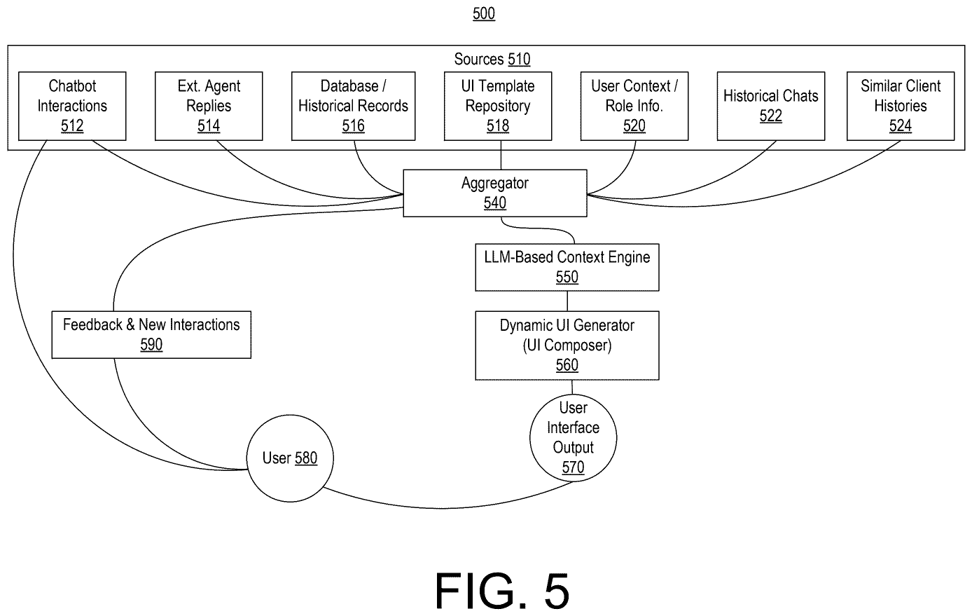

FIG. 5 shows an example of a system 500 that may be provided for GAIP implementation. As shown, the system 500 includes various sources 510, which may include sources for chatbot interactions 512, external agent replies 514, database and/or historical records 516, UI template repository 518, user context and/or role information 520, historical chats 522, and similar client histories 524 (e.g., as to individuals, teams, entities, etc.). In the example of FIG. 5, the system 500 includes an aggregator 540 that can aggregate information from one or more of the sources 510. As shown, the aggregator 540 may generate output for receipt by an LLM-based context engine 550. In such an example, the LLM-based context engine 550 can generate output for receipt by a dynamic UI generator 560, which may be referred to as a UI composer. As shown, the dynamic UI generator 560 may provide for generating suitable UI output 570, for example, to provide for instantiating, rendering, etc., one or more graphical user interfaces (GUIs) with particular features (e.g., panels, menus, controls, data links, controller links, etc.).

In the example of FIG. 5, a user 580, which may be a human and/or a machine, can interact with the UI output 570 (e.g., as a suitable interface that is interactive for utilization by a human and/or a machine) such that chat bot interactions 512 may be performed and/or such that feedback and/or new interactions 590 may be captured and responded to, for example, by the aggregator 540, which may provide for uni-directional, bi-directional, multi-directional, flows of data, etc., with one or more of the sources 510.

As to a machine interaction with UI output 570, consider an intelligent machine operator that may include one or more interfaces for direct and/or indirect interactions with the UI output 570. For example, consider a machine vision approach where one or more GUI elements may be identified using machine vision and recognized whereby one or more signals may be output to cause interaction with one or more of the one or more GUI elements. In such an example, a machine vision system may include one or more of mouse control generators, keyboard generators, etc. As an example, in a touch screen rendering of a GUI, a machine may include one or more actuatable extensions that may cause contact or sufficient hover over with a GUI element or elements to thereby cause actuation thereof.

As an example, a robot may be provided that may include machine vision technology for interactions, which may be a robot that is autonomous and/or remotely controlled. As an example, a robot approach may allow for placing a robot at a remote location and controlling the robot from a workstation. In such an example, the robot may be in a harsh environment and/or an environment with one or more human risks. As an example, a robot may be a type of drone, which may be configured for ground, water, and/or air transportation.

As explained, the system 500 may provide for generation of the UI output in an intelligent manner, for example, via implementation of a GAIP. As an example, the system 500 may include and/or provide for implementation of one or more of the example components 400 of FIG. 4.

As an example, a system, such as, for example, the system 500, may provide for dynamically building a custom user interface in real time by aggregating diverse data inputs. In such an example, the system may collect information from sources as varied as chatbot conversations, external agent replies, sensor and enterprise sources, and more. In such an approach, these aggregated data may be first processed by an aggregator (see, e.g., the aggregator 540), then interpreted by an LLM-based context engine (see, e.g., the LLM-based context engine 550) to establish a current user's needs and context (e.g., or for multiple users that may be operating in a collaborative manner). In such an approach, a UI composer (see, e.g., the dynamic UI generator 560) can generate a tailored interface that may evolve as new data or interactions come in.

As to the various sources 510 in the example of FIG. 5, consider the chatbot interactions 512 as providing data as to conversational exchanges between a user and a system's chatbot, including natural language commands, questions, and tool invocations. In such an example, natural language processing can extract user intent, keywords, urgency, and context. This information may be relevant to immediately determining what functions and UI elements may be the most relevant for the current session.

As to the external agent replies 514, consider responses from third-party APIs, external services, and specialized agents that may be queried either directly by a chatbot or as part of one or more internal workflows. Such replies may provide up-to-date, real-time context, such as operational status, live alerts, or expert recommendations. Such an approach can help to ensure that a generated UI reflects external conditions accurately.

As to one or more databases such as, for example, the database and/or historical records 516, consider sourcing of operational data (sensor & enterprise data) that may include data from real-time sensors, IoT devices, and enterprise systems (like ERP or operational logs) that provide ongoing metrics about an environment and/or business operations. Such data may inject live information into an aggregated dataset, allowing for a UI to dynamically display relevant metrics, monitor system performance, and even trigger specific UI alerts when one or more thresholds are met, exceeded, etc.

As to the UI template repository 518, consider providing a source as to a collection of predefined UI layouts, design patterns, and component libraries as may be built from past systems, structured for various use cases, etc. As an example, such a repository may offer a baseline design framework that the system 500 (e.g., or GAIP) can reference when generating a new UI. Such an approach may allow the system 500 to reuse successful patterns or merge components from multiple templates to optimize the user interface for the current context.

As to the user context and/or role information 520, consider data about a user's profile (e.g., job function, access rights, location, personalized preferences, etc.). Such data may help to ensure that a UI is tailored to a user's specific role. For instance, a field technician might receive immediate access to operational checklists and alerts, while a manager might see aggregated performance dashboards.

As to the historical chats 522 (e.g., short-term and long-term memory), this source may provide for access to and archiving of previous chat sessions and interactions, which may capture both recent and historical context. Incorporating these records adds continuity to the user experience by allowing the system to recall ongoing issues or previous recommendations. It also helps identify recurring problems and preferred solutions that can be applied automatically.

As to the similar client histories 524, this source may provide aggregated data from users with similar roles or interaction patterns. As an example, pattern recognition based on similar client examples may be implemented, for example, to allow a system to recommend best practices or UI configurations that have proven effective in analogous situations, thereby enhancing the solution for the current user.

As an example, a system may include a user behavior analytics component that may provide detailed logs of how users interact with an interface (e.g., click streams, mouse movements, dwell times, etc.). Such data may be analyzed to understand usability patterns, allowing a system to refine a UI over time. As an example, insights may help optimize load times, element placement, and overall usability to better match user expectations.

As an example, a system may include one or more proprietary simulators (e.g., one or more frameworks, etc.). In such an example, data outputs may be from one or more domain-specific simulation tools, proprietary software, etc. As an example, simulation data may provide for introducing a layer of actionable insights. As an example, simulation data, which may be or include synthetic data, may provide for understanding possible outcomes (e.g., realizations, etc.). As an example, one or more UIs may provide for rendering of results based at least in part on simulation. As an example, a UI may be generated based at least in part on simulation, for example, to provide one or more panels, controls, etc., that may facilitate workflow performance for one or more field operations. As an example, a system may provide for preview of potential outcomes or simulation of one or more operational scenarios, which may inform what content and which controls a UI may include for rendering to a display, etc.

As an example, a system may provide for GAIP implementation that includes data processing and UI generation. For example, consider an approach that includes data aggregation and context processing where data sources feed into an aggregator, which may provide for normalizing, synchronizing, and filtering diverse inputs into a consistent format. In such an example, aggregated data may then be passed to an LLM-based context engine, where advanced natural language models may provide for extracting user intent, contextual nuances, and environmental metrics to produce a clear directive for UI generation. As to dynamic UI generation, consider implementation of a UI composer that is operatively coupled to the LLM-based context engine or multiple LLM-based context engines. In such an approach, a UI composer may receive directives and assembled parameters from one or more context engines. As an example, a UI composer may reference one or more templates in a UI template repository and dynamically arrange visual and interactive elements accordingly. As an example, an outcome of a dynamic approach may be a dynamic context-aware, dynamically generated UI that may be rendered to one or more displays. In such an example, such a UI may be dynamically linked to one or more components of a GAIP, which may provide for dynamic revisions, which may be based on feedback, interactions, additional user (e.g., collaborator), data (e.g., sensor data, etc.), workflow phase, etc. As explained, a UI may continuously adapt to circumstances, which may include new data, which may be acquired through one or more ongoing sensor feeds, updated enterprise metrics, further user interactions, etc., to help create a feedback loop, for example, where individual and/or collective user actions may inform successive UI adaptations.

As explained, a GAIP may provide for operations based on continuous feedback and/or adaptation. As explained, feedback from a user (via interactions with a chatbot and/or direct interface changes) may be re-injected into an aggregator. Such an approach may provide for utilization of continuous feedback to form a loop that allows for refining understanding of user needs over time, adapting layouts on the fly, and ensuring that a generated UI remains relevant and effective in addressing the user's demands.

As an example, a GAIP may provide for AI-driven adaptive UI/UX for facility monitoring and/or control. For example, consider a facility that may include one or more of a chemical plant, an oil and/or gas refinery, a manufacturing facility, a data center, a carbon capture plant, a solar plant, a geothermal plant, a lithium plant, etc.

As an example, a GAIP may provide for user interface and user experience (UI/UX) design in one or more industrial facility management systems by leveraging generative AI to dynamically create contextually appropriate interfaces based on real-time conditions, event criticality, model driven insights, optimization opportunities, design and process improvements. As explained, a GAIP can provide for adapting a presentation layer in real-time to optimize operator awareness, ability to recognize, to respond, to make decisions and to take actions in a highly efficient and dynamic environment (e.g., control actions, etc.).

As explained, a GAIP may provide for real-time adaptability, dynamic reconfiguration of interface elements (e.g., based on current facility state, etc.), automatic prioritization and emphasis of relevant information, context-aware presentation of controls and data, and intelligent filtering of non-essential information during one or more of particular events.

As explained, a GAIP may provide for AI-driven optimization of one or more UIs, which may be accomplished via use of one or more machine learning models (e.g., trained on historical operator interactions, etc.), pattern recognition (e.g., for early event classification, etc.), predictive analytics (e.g., for one or more facility states), continuous learning (e.g., from operator responses and outcomes, etc.), generation of recommendations (e.g., as to improved operating zone(s) based on historical data, etc.), and end-to-end value chain optimization.

As an example, contextual awareness may be achieved by a GAIP using one or more of integration of facility sensor data, event severity assessment, operator role and state consideration, environmental condition incorporation, time-based context analysis, regulatory requirement integration, and HSE awareness.

As an example, personalization capabilities may be achieved by a GAIP using one or more of role-based interface adaptation, experience-level considerations, shift pattern awareness, historical interaction pattern integration, cognitive load optimization, and best practices recommendations.

As an example, a GAIP may provide for one or more of: enhanced usability via one or more of personalization (e.g., adapting to user preferences, habits, or device usage improves intuitiveness) and reduced cognitive load (e.g., via displaying relevant options (e.g., without or lesser other graphics), users reduction of information overload, making tasks simpler to complete, etc.); improved efficiency, for example, via faster task completion (e.g., by preemptively adapting to user demands (e.g., showing frequent tools or features), users spend less time navigating, etc.), and seamless multitasking (e.g., context-aware UIs may provide quick switches between tasks and/or save user progress dynamically); greater accessibility, for example, via adaptive assistance (e.g., interfaces that may adapt based on user abilities, like switching to voice interaction for visually impaired users) and real-time adjustments (e.g., dynamically changing font size, contrast, or interaction mode helps users with varying demands); increased user satisfaction, for example, via contextual relevance (e.g., where users feel understood when a UI aligns with their immediate goals or environment) and consistency across devices (e.g., adaptability that helps to ensure seamless transitions across different platforms (e.g., desktop to mobile)); optimized resource use, for example, via efficient system performance (e.g., generating adapting UIs to user context to help ensure a limited number of elements load that may help to conserve resources) and energy efficiency (e.g., for battery-powered devices, context-aware interfaces that may provide for disabling non-essential features, etc.); and enhanced HSE compliance.

As an example, a GAIP may provide for dynamic capabilities that improve upon other approaches that may be limited to one or more of: fixed interface constraints (e.g., inability to adapt to changing conditions, one-size-fits-all approach, limited contextual consideration, and fixed information hierarchy); manual configuration requirements (e.g., time-consuming setup, expert knowledge needed, maintenance overhead, and limited flexibility); limited Intelligence (e.g., lack of real-time optimization, lack of learning capabilities, static decision support, and fixed alarm prioritization); and operator challenges (e.g., cognitive overload during critical events, information overload, context switching overhead, and fixed navigation patterns).

As explained, a GAIP may provide a system for dynamically generating and adapting user interfaces in industrial facility management environments. In such an example, the system may employ advanced artificial intelligence and machine learning techniques to create contextually appropriate interfaces that respond to real-time facility conditions, event criticality, and operator context.

### Example System

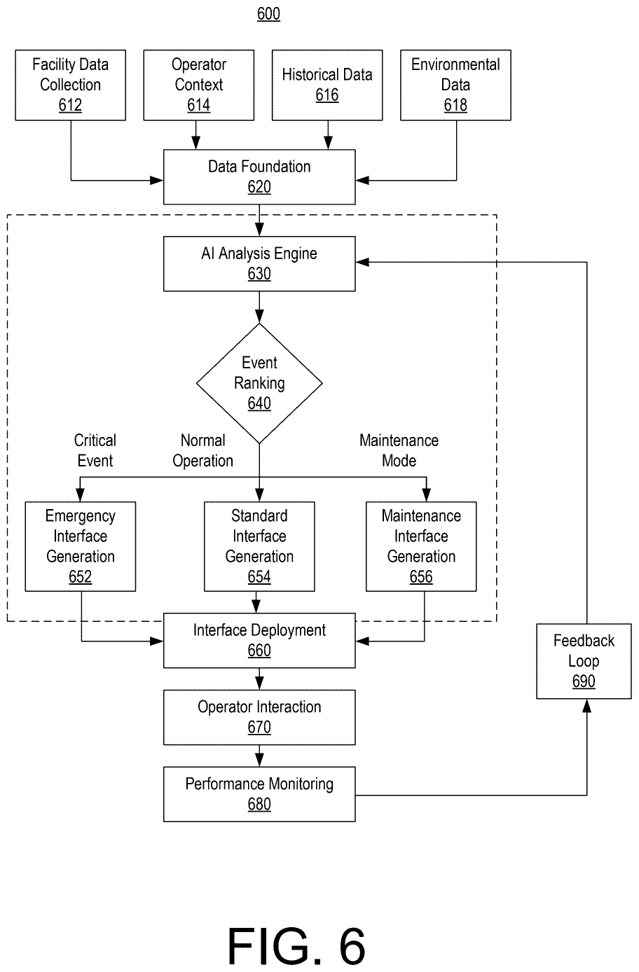

FIG. 6 shows an example of a system 600 that may provide for implementation of a GAIP for one or more purposes. As shown, the system 600 may include various sources of data, which may include a facility data collection 612, operator context 614, historical data 616, and environmental data 618. As shown, a data foundation component 620 may provide for receipt of data from one or more sources.

As shown in the example of FIG. 6, various components may be part of a GAIP, for example, as shown within a dashed rectangle. As an example, an AI analysis engine 630 can be included and operatively coupled to one or more data foundation components, such as, for example, the data foundation component 620. In such an example, the AI analysis engine 630 can generate output that may be received by an event ranking component 640, which may provide for event classification. In the example of FIG. 6, ranking and/or classification may provide for ranks and/or classes such as critical events, normal operation, and maintenance mode. Such an approach may make UI generation more efficient and focused. For example, consider utilization of an emergency interface generation component 652, a standard (normal) interface generation component 654, and a maintenance interface generation component 656. While the example of FIG. 6 shows three particular examples, one or more other examples may be utilized, additionally or alternatively.

As shown in the example of FIG. 6, output from one or more of the interface generation components 652, 654, and 656, may be directed to an interface deployment component 660. In such an approach, an operator interaction component 670 may provide for acquisition of interactions with one or more UIs where, for example, a performance monitoring component 680 may provide for acquisition of feedback that may be implemented in a feedback loop 690, which may cycle back to the AI analysis engine 630. In such an approach, feedback may provide for labeling, training, re-training, hyperparameter tuning, etc., of one or more machine learning models.

As an example, a system architecture can include various layers, which may be categorized as a data acquisition and integration layer, a data contextualization layer (e.g., to contextual data as to a real-world scenario), and an artificial intelligence (AI) aided analysis layer for generating output for rendering of one or more dynamic user interfaces. In such an example, the AI-aided analysis layer may be operatively coupled to a dynamic UI generation layer of the system architecture. As an example, such a system architecture may include an interaction model generator, feedback and learning components, and one or more other components.

As an example, a data acquisition and integration layer may provide for establishing continuous connections with one or more facility sensor networks, process control systems, and environmental monitoring devices. Such a layer may ingest real-time data streams from multiple sources, which may include, for example, one or more of pressure sensors, temperature gauges, flow meters, and one or more other types of industrial instrumentation. As an example, such a layer may provide for maintaining connections with one or more of historical databases, operator interaction logs, and facility maintenance records. Such a comprehensive data acquisition and integration approach may help to ensure that a system has visibility into current and historical facility states.

As an example, a data contextualization layer may provide for integration of data from various sources, for example, to create a unified, consistent framework. As an example, such a layer may provide for harmonizing disparate data formats, structures, and semantics and, for example, enable seamless interoperability across platforms and ensures that raw data and/or other data (e.g., attributes, metrics derived from data, synthetic data, etc.) may be effectively utilized in an origin agnostic manner. Such an approach to integration may be beneficial, particularly for organizations that rely on data from multiple sources, such as sensors, APIs, and databases, to drive decision-making.

As explained, a layer may provide for context awareness. For example, context awareness may take into consideration various types of situational factors, such as, for example, time, location, user preferences, and operational parameters to ensure that data align with a specific environment, domain, etc., in which such data are being utilized. For example, a contextualization layer in an industrial setting may provide for prioritizing data from one or more specific machines based on their operational status and/or location within a facility.

As an example, a layer may provide for enriching raw data, for example, by associating it with metadata, historical trends, external datasets, etc., which may provide for improving transformation it into one or more actionable insights. As an example, an enrichment process may integrate domain-specific knowledge, enabling various capabilities, which may include, for example, anomaly detection, predictive analysis, and control. As an example, consider a GAIP that can provide for anomaly detection using one or more machine learning models where one or more control actions may be output for addressing one or more anomalies and/or risk thereof as to performance and/or non-performance of one or more field operations associated with subsurface and/or surface equipment, processes, etc. As an example, by embedding deeper context within data using layer components, the data can become more relevant and valuable for decision-making.

As explained, a GAIP may provide for real-time processing that aims to enable a contextualization layer to deliver insights as events occur (e.g., dynamic UI generation, adaptation, etc.). Such an approach may help to ensure that decision-makers, whether human and/or machine, have access to timely and actionable information regarding resources, facilities, etc. In dynamic environments, such as, for example, industrial operations or healthcare, an ability to process and contextualize data in real-time can be beneficial to achieving or assuring optimal outcomes.

As an example, a data contextualization layer may provide for presentation of information in a user-centric manner, tailoring outputs to specific audience demands. For instance, engineers may demand relatively granular technical metrics, while those that may be responsible for balancing overall efficiency (e.g., resources produced, costs thereof, market value, etc.) may demand high-level summaries and/or various performance indicators (PIs). As explained, a GAIP may provide for automated customization of UIs, actions, etc., in a manner that helps to ensure that data and outputs are relevant and readily interpretable for intended purpose or purposes.

As an example, an AI analysis engine may provide for receipt of data whereby multiple specialized neural networks and machine learning models may be implemented for generating data-derived output. As an example, an AI engine may employ pattern recognition to identify emerging situations and classify events based on one or more predefined classes and/or unknown classes, along with, for example, possible impact of one or more emerging situations. As explained, a GAIP may be dynamic and provide for continuously analyzing data, operator behavior patterns, system responses, historical outcomes, etc., to generate, refine, adapt, etc., output, which may provide for decision-making capabilities (e.g., human and/or machine control actions).

As an example, an AI engine may be or include one or more machine learning models. For example, consider an engine that may incorporates supervised and unsupervised machine learning models. In such an example, supervised machine learning components may be trained on historical event data and known good responses, while unsupervised machine learning components may provide for identification of new patterns, anomalies, etc., which may lead to issuance of one or more control instructions for action in the field using field equipment. As an example, an AI engine may utilize one or more deep learning techniques, for example, to understand complex relationships between different facility parameters and their impact on operational safety and efficiency.

As an example, an AI layer may provide for event processing using one or more techniques, which may include one or more of real-time event classification, severity assessment algorithms, pattern recognition, anomaly detection, predictive analytics, and risk assessment.

As an example, an AI layer may provide for context analysis, for example, using one or more of operator state evaluation, facility state assessment, environmental condition analysis, regulatory requirement checking, historical pattern analysis, and resource availability assessment.

As an example, an AI layer may provide for interface optimization, for example, using one or more of layout optimization algorithms, information prioritization, visual hierarchy determination, interaction pattern optimization, cognitive load assessment, and accessibility considerations.

As explained, a GAIP may include one or more components for dynamic UI generation, which may be for various types of UIs and/or for a specific type of UI. For example, in the example of FIG. 6, one or more UI generation components may be provided. As an example, dynamic UI generation may receive output from an AI layer and transforms that output into concrete interface elements. In such an example, a comprehensive library of interface components may be relied upon where, for example, each element may be designed for one or more particular types of interactions and/or information display. As an example, such interface components may be based on parametric designs that can be dynamically configured based on current demands. As an example, an approach may include utilizing one or more templates and/or designing on-demand one or more templates, interface components, etc.

As an example, when generating an interface, a system may consider multiple factors, which may include, for example, one or more of screen real estate, information hierarchy, color psychology, and cognitive load principles. As an example, for particular events (e.g., alarms, etc.), a system may act to reduce presentation of non-essential information and may act to enhance visibility of particularly relevant controls (e.g., to address an anomaly, etc.). As an example, during normal operations, a system may provide for presentation to detailed information in a balanced layout (e.g., for overall facility awareness, etc.).

As an example, a generation component may provide for implementation of one or more relatively sophisticated layout generators that may help to ensure that proper information spacing, grouping, visual hierarchy, etc., are achieved. As an example, a generation component may provide for dynamically adjusting font sizes, color schemes, and contrast ratios based on environmental conditions such as lighting or operator fatigue levels. As an example, a generation component may provide for dynamically adjusting one or more visual elements, notifications (e.g., sounds, etc.), in a manner corresponding to field conditions. For example, consider increasing font size, changing font color, flashing elements, etc., responsive to one or more escalating field conditions that may give rise to increased risks.

As an example, a GAIP can include one or more layout engines. For example, consider a layout engine that may provide for one or more of UI component placement optimization, screen real estate management, resolution adaptation, multi-screen support, and device-specific optimization.

As an example, a GAIP can include one or more visualization components. For example, consider one or more of a dynamic chart generation component, a real-time data visualization component, an alert visualization component, a process flow representation component, a status indicator generation component, and a trend analysis display component.

As an example, a GAIP can include one or more interaction models. For example, consider one or more interaction models for one or more of control scheme optimization, navigation pattern generation, gesture support, voice interaction integration, and multi-modal interaction support.

As an example, a GAIP can include an interaction model generator, which may be machine learning model-based. For example, consider an approach where interactions can be received and assessed to uncover one or more interaction sequences, patterns, etc. In such an example, consider adapting a UI such that graphical controls that are utilized in sequence are closely spaced (e.g., close distance-wise) such that a mouse or other movement of an HMI may be minimized when actuating one graphical control after actuating another graphical control. In another example, consider spacing graphical controls such that a cursor must traverse a particular panel with relevant representations such that a user's attention is drawn to those relevant representations prior to deciding whether or not to actuate a particular graphical control. For example, consider an assessment graphical control to determine whether an anomaly exists on one side of a panel and a control action graphical control on an opposing side of the panel where the panel includes sensor data and optionally other data (e.g., synthetic, etc.) that may provide for indicating where, when, why, etc., the anomaly occurred or may occur such that the user is more likely to view and understand the anomaly or risk thereof before actuating a control graphic that causes field equipment to perform a responsive action (e.g., anomaly avoidance, mitigation, etc.).

As an example, a GAIP may provide for generation of appropriate interaction models, for example, based on a current context. For example, during emergency situations, a GAIP may generate and implement one or more larger touch targets and demand confirmation for one or more particular actions. As to normal operations, a GAIP may generate and offer more nuanced controls and detailed information displays. As an example, an interaction model can adapt to an operator's role, experience level, historical interaction patterns, etc.

As an example, a generator can include support for multiple input modalities including, for example, one or more of touch, keyboard/mouse, voice commands, and gesture controls. As an example, a generator may provide for dynamically switching between various modes based on situation and/or operator preference. For example, during hands-busy operations, a GAIP generator may prioritize voice controls over touch interactions.

As an example, a generator may provide for one or more of control scheme optimization, navigation pattern generation, gesture support, voice interaction integration, and multi-modal interaction support.

As explained, a GAIP may include one or more components for feedback and learning support. For example, a GAIP may include a feedback loop that can continuously monitor effectiveness of generated interfaces. As an example, a GAIP may track metrics such as, for example, one or more of operator response times, error rates, and task completion success. As an example, a GAIP may provide for monitoring one or more indirect indicators such as, for example, operator stress levels through interaction patterns and biometric data when available.

As an example, a GAIP may provide for receiving operator data. For example, consider a user that has a wearable health or fitness monitoring device. In such an example, heart rate, heart rate variability, change in heart rate, movement, temperature, skin conductivity, etc., may be monitored. As an example, a display system may include one or more integrated cameras, which may include a visual light camera, an infrared camera, etc. In such an example, camera sensor data may provide for assessing operator (e.g., user) status, which may include stress level, eye movement, head movement, etc. As an example, one or more types of driver-awareness features may be implemented, for example, to assure an operator's eyes are sufficiently open, head in a proper position, etc. In such an example, a GAIP may provide for dynamic UI generation, adaptation, etc., can account for a user and state of the user, which may be for snapshots in time, trends over time, etc.

As an example, a GAIP may provide for generation of one or more UIs that may help to address user state issues. For example, consider a GAIP that may determine that a facility may be in a relatively stable stead-state for a period of time at present or in the future. In such an example, the GAIP may provide for rendering of a stress reducing or relaxing UI whereby soothing music, nature scenes, etc., may be rendered (e.g., via audio, video, etc.) for a period of time, where, if available, monitoring of user response may be monitored to determine whether the selected approach is effective for the particular user or not (e.g., or to what agree). As explained, a GAIP may operate adaptively where, for example, the GAIP may learn and respond to a user in a manner that is driven by the GAIP. In such an approach, the GAIP may effectively perform its own experimentation for a user or users to learn and more effectively generate dynamic UIs in response.

As an example, a GAIP may process feedback using one or more types of models. For example, consider implementation of one or more analytical models that identify correlations between interface configurations and operational outcomes, which may also account for user experience (e.g., user behavior). As an example, results based on a model or models may be fed back into an AI engine, for example, to refine decision-making processes and improve future interface generations. As an example, a GAIP may implement one or more reinforcement learning techniques, which may help to optimize interface configurations over time.

As an example, a feedback approach may involve one or more of performance metric collection, response time analysis, error rate tracking, user satisfaction assessment, system effectiveness evaluation, and continuous improvement engine.

As an example, a system may provide for dynamically generating user interfaces in industrial facilities. In such an example, the system may include a data acquisition component for acquiring real-time facility state information, an AI analysis engine for processing facility state and event data, a dynamic interface generation component, and feedback collection and learning components, where such a system can generates and modify user interfaces based on real-time facility conditions and event assessment (e.g., classification, ranking, etc.).

As an example, a system may provide for one or more of real-time event classification capabilities, context analysis functionality, interface optimization algorithms, and performance monitoring.

As an example, a method may provide for dynamically generating user interfaces in industrial facilities. In such an example, the method may include acquiring real-time facility state data, analyzing current conditions using one or more AI algorithms, generating one or more optimized interfaces based on analysis results, deploying dynamic interfaces in real-time, acquiring performance metrics, and updating one or more optimization algorithms based on one or more of such performance metrics.

As an example, a method may provide for interface generation for one or more of current facility state, event criticality, operator context, historical response patterns, and environmental conditions.

As an example, a computer-implemented method for optimizing industrial facility interfaces may include monitoring facility conditions in real-time, classifying events using one or more AI algorithms, generating context-appropriate interfaces, deploying dynamic interfaces, acquiring performance metrics, and dynamically updating one or more interface optimization parameters.

As an example, a system may provide for AI-driven interface adaptation where the system may include sensors for monitoring facility conditions, processors for analyzing facility state, one or more interface generation engines, performance monitoring components, and one or more learning algorithms for continuous improvement.

As an example, a system may include components for one or more of multi-modal interaction support, device-specific optimization, role-based customization, and context-aware presentation logic.

As an example, a method may provide for cognitive load optimization in industrial interfaces. In such an example, such a method may include monitoring operator interaction patterns, analyzing event criticality, adjusting information density, optimizing visual hierarchy, acquiring performance metrics, and updating optimization parameters.

### Example System

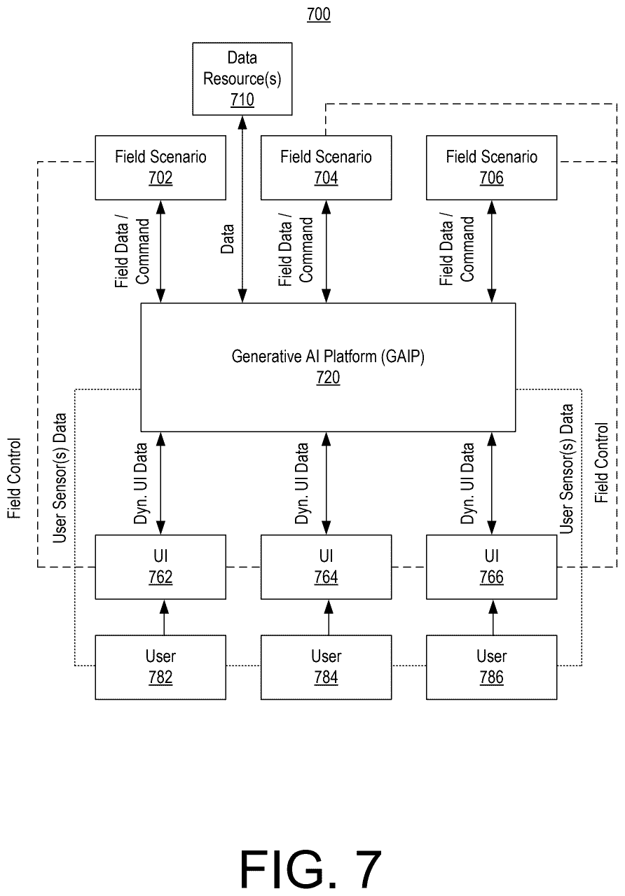

FIG. 7 shows an example of a system 700 that includes various field scenarios 702, 704, and 706, one or more data sources 710, a GAIP 720, user interfaces (UIs) 762, 764, and 766, along with users 782, 784, and 786. As shown, the GAIP 720 can receive field data from the field scenarios 702, 704, and 706, along with data from the one or more sources 710. In such an example, the GAIP 720 can generate the UIs 762, 764, and 766 for interactions with the users 782, 784, and 786. As shown, the UIs 762, 764, and 766 can generate output for control of one or more actions in the field scenarios 702, 704, and 706. Further, as mentioned, depending on capabilities of equipment at a user, user sensor(s) data may be generated and received by the GAIP 720. As explained, the GAIP 720 can be dynamic and responsive to changing circumstances, workflow tasks, stages, phases, etc., and, for example, dynamic and responsive to user sensor(s) data.

As an example, a field scenario may involve wellhead monitoring at one or more wellsites. As explained, a wellhead may be fit with equipment that may provide for sensing fluid flow, fluid pressure, fluid composition, etc., and may that may provide for controlling fluid flow, fluid pressure, fluid composition, etc. As an example, a wellhead may be fit with an adjustable choke that may be controlled locally and/or remotely. As an example, a wellhead may be fit with equipment for artificial lift. In such an example, artificial lift equipment may provide for adding energy to a fluid column in a wellbore to initiate or improve production of fluid from a well. Artificial lift equipment may include one or more of rod pumping, gas lift, and electric submersible pump equipment. As to gas lift, it can involve injecting gas into a wellbore. In various instances, one or more other types of fluid may be injected at a wellhead into a wellbore. For example, consider a treatment fluid that may aim to treat a wellbore, a formation, etc.

As explained, a wellhead may include one or more types of sensors. For example, consider one or more pressure sensors that can measure fluid pressure at a wellhead (e.g., to help ensure that fluid pressure remains within operational limits, etc.), consider one or more temperature sensors (e.g., for sensing temperature of extracted fluids to prevent overheating, ensure equipment safety, etc.), consider one or more flow meters (e.g., to track flow rate of fluid, which may include liquid and/or gas, to optimize production levels, etc.).

As to examples of data, consider, for example, geological data concerning subsurface formations and reservoir characteristics, historical production data concerning past production rates and well performance metrics. As an example, a system may include or be operatively coupled to one or more data stores (e.g., databases, etc.). As an example, a data store may be local or remote (e.g., consider a data store hosted in a cloud platform).

As an example, a generative AI-based platform (GAIP) may include various components that provide for workflow execution using one or more processors. In such an example, data may be acquired using one or more interfaces, which may be networked to equipment, whether via wire or wireless technologies. As an example, control instructions may be transmitted via one or more interfaces, which may be networked to equipment, whether via wire or wireless technologies.

As an example, a GAIP may provide for execution of a real-time monitoring workflow that aggregates data from wellhead sensors to provide a comprehensive view of well performance. In such an example, the GAIP may provide for execution of predictive analytics, for example, using historical and real-time data to predict potential issues, which may include one or more of pressure drops and equipment failures (e.g., downhole equipment, surface equipment, downhole and surface equipment, etc.). In such an example, the GAIP may provide for execution of an optimization routine that can issue control instructions to adjust one or more production parameters to maximize output while maintaining safety and equipment integrity. For example, relationships may exist between fluid flow, fluid composition, fluid temperature, fluid pressure, etc., where a GAIP may provide for control of one or more parameters to optimize well performance.

As an example, one or more user interfaces may be generated, which may include one or more graphical user interfaces that may be rendered to one or more displays for purposes of user interactions where a user may be a human and/or a machine (e.g., consider robotic interactions using machine vision, etc.). As an example, a UI may be generated that can render real-time data as to wellhead conditions and production rates. In such an example, a user may be a production engineer that is responsible for reviewing conditions and production rates, reviewing suggested control actions, implementing control actions, etc. As an example, responsive to one or more conditions, production rates, etc., a UI may be dynamic and provide for rendering, highlighting, etc., a graphical control actuatable to provide control of field equipment. For example, consider a UI that may dynamically render a graphical control actuatable to control a choke, a sensor, an electric submersible pump, a downhole valve (e.g., a gas lift valve that may be set in a mandrel, etc.), a sucker-rod pump (SRP), etc. As an example, a UI may be tailored to a role. For example, consider a UI tailored to an individual for monitoring wellhead performance, responding to alerts, adjusting one or more production parameters, as appropriate, to optimize output and ensure safety.

As an example, a field scenario may involve taking actions with respect to a gas processing plant. In such an example, sensors may include gas analyzers that measure composition of natural gas (e.g., to assess quality, etc.), level sensors that monitor levels of liquids in separators and storage tanks, temperature sensors for acquiring temperature measurements to help ensure that processing conditions remain optimal for efficient gas separation and treatment.

As an example, a field scenario may involve accessing pipeline integrity data, which may include historical data on pipeline inspections and maintenance records. For example, consider data pertaining to a leak and a repair of the leak at a particular location. In such an example, one or more signatures may be generated or assessed as to fluid flow, pressure, temperature, etc., corresponding to the leak and/or the repair. For example, in an ocean bottom setting, if external pressure is greater than internal pressure, sea water may actually flow from an external environment into a pipeline, which may be noted by one or more of fluid flow, pressure and temperature data. Such a type of leak may be challenging to detect as an “oil spill” may not manifest as an indicator because sea water is entering the pipeline rather than oil exiting the pipeline. As to repairs, data may provide a root cause type of assessment as to how or why a leak occurred, how it was detected, and how the pipeline and other equipment were managed before, during, and after repair. As an example, a scenario may involve accessing market data on-demand, which may provide for balancing one or more factors. For example, consider balancing equipment concerns with value of a resource concerns. In such an example, equipment wear, costs, emissions, etc., may be taken into account with respect to value of a produced, processed, and marketable resource.

As an example, a GAIP may provide functionality for condition monitoring for continuously assessing conditions of processing equipment to help mitigate or prevent failures, for quality control for assuring that processed gas meets regulatory and market standards, for process optimization for adjusting one or more processing parameters in an effort to improve efficiency and reduce costs.

As an example, a user interface may be generated, which may be a graphical user interface (GUI) renderable to a display for machine and/or human interactions. As an example, a UI may provide for rendering graphics, controls, etc., to gain and leverage plant manager insights, which may improve processing efficiency and product quality. As explained, product quality may be related to a market factor, such as, for example, value of a marketable product. As an example, quality may be balanced, or optimized, in a real-time manner that may depend on market conditions. For example, if a higher quality product is in demand, then field equipment may be managed to produce such a product; whereas, if demand decreases for such a product, a framework may provide for optimization of a system for generation of a lower quality product in a cost-effective manner. As an example, a lifecycle analysis may be utilized, which may include cradle-to-cradle and/or cradle-to-grave metrics.

As an example, a UI may be tailored to a particular role, such as, for example, a plant manager. In such an example, the UI may provide functionality for overseeing gas processing operations, ensuring compliance with quality standards, and optimizing one or more processing parameters to enhance efficiency and profitability.

As explained, a framework can provide for improved accuracy and predictive insights. As an example, a framework may provide an ML-based solution that offers rapid and accurate forecasting and that provides predictive insights that can aide in proactive decision-making at one or more phases (e.g., site selection, design, control, etc.). As an example, a framework may be integrated with one or more other frameworks or within a framework environment. For example, consider integration with the PETREL framework and/or integration within the DELFI environment.

As explained, a framework may provide for efficient data processing and real-time adaptability. A framework may provide an ability to efficiently process datasets and adapt in near real-time to new data and/or changing conditions. Such a framework may facilitate quicker, data-driven decisions that lead to optimized operations and improved resource allocation.

As explained, a framework may provide for customized objective functions, whether for single variable or multi-variable optimizations. Such flexibility to define custom objective functions can allow for a tailored optimization approach, which may aim to align closely with specific operational and resource goals. Such an approach may improve outcomes due at least to objective function flexibility compared to more rigid, pre-defined optimization techniques.

As explained, a framework may be scalable and adaptable. For example, an ML-based approach can be scalable to accommodate large amounts of field data and/or to augment field data (e.g., via transformations, synthetic field data, etc.) and may be adaptable for one or more types of scenarios, facilities, etc. Such an approach can aim to meet diverse operational demands, making a framework a more versatile and future-proof product.

As explained, a system, a GAIP, etc., may utilize one or more types of machine learning models. As to types of machine learning (ML) models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, one or more features of the KERAS library may be utilized. The KERAS library is an open-source library that provides a Python interface for artificial neural networks (ANNs). The KERAS library can act as an interface for the TENSORFLOW library.

As an example, a device may utilize TENSORFLOW LITE (TFL) or another type of lightweight framework. TFL is a set of tools that enables on-device machine learning where models may run on mobile, embedded, and IoT devices. TFL is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). TFL includes multiple platform support, covering ANDROID and iOS devices, embedded LINUX, and microcontrollers. TLF provides diverse language support, which includes JAVA, SWIFT, Objective-C, C++, and PYTHON. TFL provides high performance, with hardware acceleration and model optimization. As an example, one or more machine learning tasks may include, for example, classification, regression, object detection, pose estimation, question answering, text classification, etc., on one or more of multiple platforms.

### Example Method and Example System

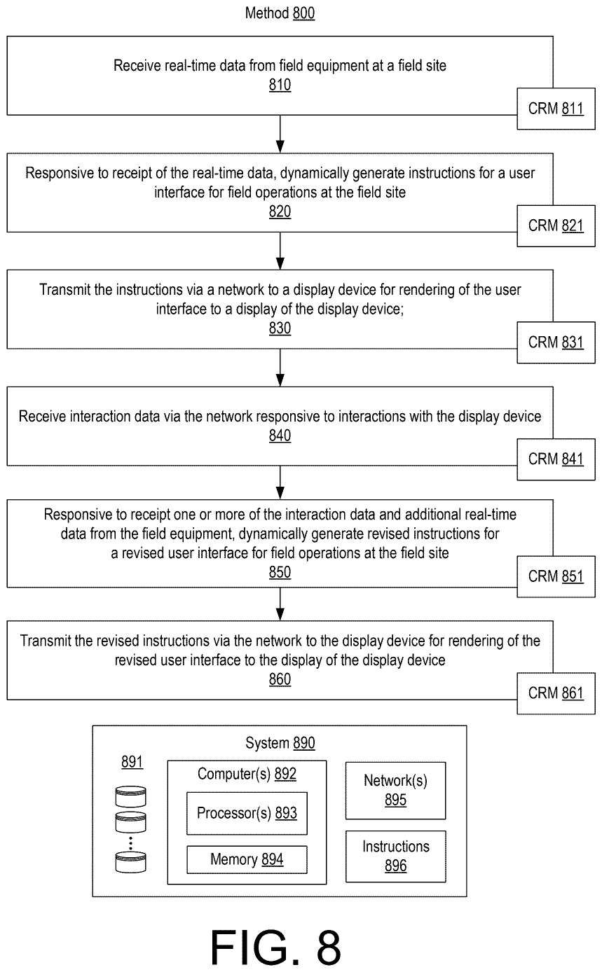

FIG. 8 shows an example of a method 800 and an example of a system 890. As shown, the method 800 can include a reception block 810 for receiving real-time data from field equipment at a field site; a generation block 820 for, responsive to receipt of the real-time data, dynamically generating instructions for a user interface for field operations at the field site; a transmission block 830 for transmitting the instructions via a network to a display device for rendering of the user interface to a display of the display device; a reception block 840 for receiving interaction data responsive to interactions with the display device; a generation block 850 for, responsive to receipt one or more of the interaction data and additional real-time data from the field equipment, dynamically generating revised instructions for a revised user interface for field operations at the field site; and a transmission block 860 for transmitting the revised instructions via the network to the display device for rendering of the revised user interface to the display of the display device.

The method 800 is shown in FIG. 8 in association with various computer-readable media (CRM) blocks 811, 821, 831, 841, 851, and 861. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 800. As an example, a computer-readable medium (CRM) may be a computer-readable storage medium that is non-transitory and that is not a carrier wave. As an example, one or more of the blocks 811, 821, 831, 841, 851, and 861 may be in the form processor-executable instructions.

In the example of FIG. 8, the system 890 includes one or more information storage devices 891, one or more computers 892, one or more networks 895 and instructions 896. As to the one or more computers 892, each computer may include one or more processors (e.g., or processing cores) 893 and memory 894 for storing the instructions 896, for example, executable by at least one of the one or more processors 893 (see, e.g., the blocks 811, 821, 831, 841, 851, and 861). As an example, a computer may include one or more network interfaces (e.g., wired or wireless), one or more graphics cards, a display interface (e.g., wired or wireless), etc.

As an example, a method can include receiving real-time data from field equipment at a field site; responsive to receipt of the real-time data, dynamically generating instructions for a user interface for field operations at the field site; transmitting the instructions via a network to a display device for rendering of the user interface to a display of the display device; receiving interaction data responsive to interactions with the display device; responsive to receipt one or more of the interaction data and additional real-time data from the field equipment, dynamically generating revised instructions for a revised user interface for field operations at the field site; and transmitting the revised instructions via the network to the display device for rendering of the revised user interface to the display of the display device.

As an example, a method can include dynamically generating instructions in a manner that includes detecting a number of events based on real-time data. In such an example, the method can include classifying the number of events into classes. For example, consider utilizing classes that include an emergency class, a normal operational class, and a maintenance class.

As an example, a method can include dynamically generating instructions in a manner that includes executing a machine learning model. In such an example, the machine learning model can be or include a large language model.

As an example, a method may include generating a graphical user interface that includes a chat graphical control where interactions with the chat graphical control generate at least a portion of interaction data. In such an example, the interactions with the chat graphical control can cause a large language model to generate output, where, for example, the method may include dynamically generating revised instructions for a revised user interface in a manner that includes utilizing at least a portion of the output.

As an example, a method can include dynamically generating instructions for a user interface in a manner that includes accessing a template database and selecting a template from a template database.

As an example, a method can include dynamically generating instructions for a user interface in a manner that includes accessing a visual elements database and selecting one or more of the visual elements from the visual elements database. In such an example, selection of one or more visual elements may depend on real-time data and/or an assessment thereof (e.g., classification thereof, etc.).

As an example, a revised user interface, when compared to an existing user interface, may include a larger text font size than that of the existing user interface and/or may include a different font color than that of the existing user interface.

As an example, a method can include receiving user sensor data from one or more user sensors, where the method includes dynamically generating revised instructions for a revised user interface in a manner that depends on at least a portion of the user sensor data. In such an example, the one or more user sensors may include one or more of a heart rate sensor, an infrared sensor, and a video camera sensor. In such an example, a user may be a human or a machine (e.g., a robot, etc.).

As an example, a field site may be an oil and gas industry site and/or a carbon sequestration industry site. As an example, a method may be tailored to account for emissions and/or utilization of one or more energy sources. As an example, a method may account for utilization a portion of a produced resource for powering one or more machine at a field site or field sites. For example, consider a field that may produce oil and gas where gas may be utilized for one or more purposes (e.g., power generation, artificial lift, etc.). In such an example, a method may optimize separations, processing, flow, etc., of gas. In various instances, field operations may include flaring of gas, which may depend on one or more conditions, factors, etc. For example, consider weather, market value, fluid composition, artificial lift, etc.

As an example, a method may include identifying a user of a user interface and accessing a user preferences database for user preference data for the user, where, in such an example, the method may include dynamically generating instructions for a user interface in a manner that generates the instructions based at least in part on the user preference data.

As an example, a method may include identifying a geographical location of a display device, where, for example, the method may include dynamically generating instructions for a user interface in a manner that generates the instructions based at least in part on the geographical location of the user. For example, consider aspects such as left-to-right and right-to-left layouts, languages, regional regulatory bodies, types of field equipment, general practices, etc.

As an example, a system can include a processor; a memory operatively coupled to the processor; and processor-executable instructions stored in the memory and executable to instruct the system to: receive real-time data from field equipment at a field site; responsive to receipt of the real-time data, dynamically generate instructions for a user interface for field operations at the field site; transmit the instructions via a network to a display device for rendering of the user interface to a display of the display device; receive interaction data responsive to interactions with the display device; responsive to receipt one or more of the interaction data and additional real-time data from the field equipment, dynamically generate revised instructions for a revised user interface for field operations at the field site; and transmit the revised instructions via the network to the display device for rendering of the revised user interface to the display of the display device.

As an example, one or more computer-readable storage media can include processor-executable instructions executable by a system to instruct the system to: receive real-time data from field equipment at a field site; responsive to receipt of the real-time data, dynamically generate instructions for a user interface for field operations at the field site; transmit the instructions via a network to a display device for rendering of the user interface to a display of the display device; receive interaction data responsive to interactions with the display device; responsive to receipt one or more of the interaction data and additional real-time data from the field equipment, dynamically generate revised instructions for a revised user interface for field operations at the field site; and transmit the revised instructions via the network to the display device for rendering of the revised user interface to the display of the display device.

As an example, a computer program product can include one or more computer-readable storage media that can include processor-executable instructions to instruct a computing system to perform one or more methods and/or one or more portions of a method.

### Example System

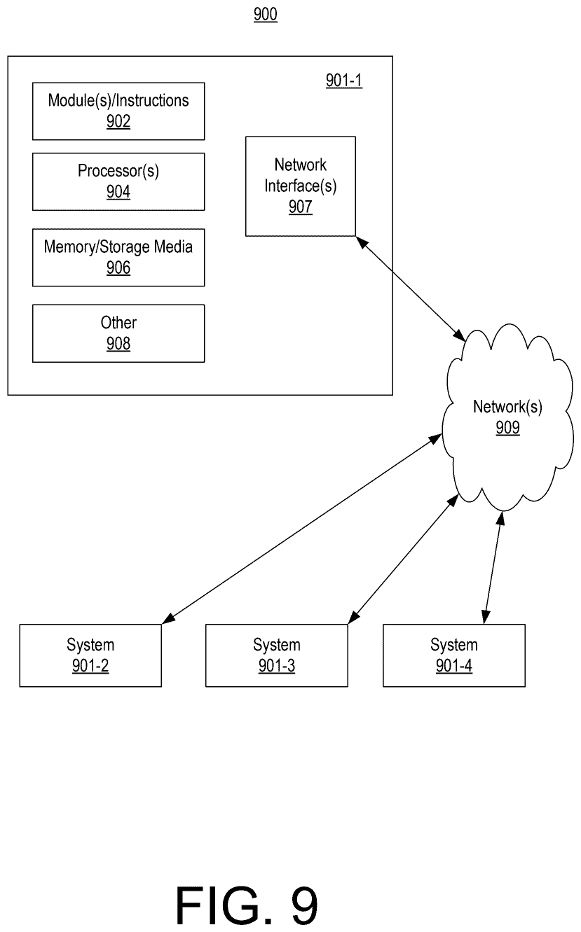

In some embodiments, a method or methods may be executed by a computing system. FIG. 9 shows an example of a system 900 that can include one or more computing systems 901-1, 901-2, 901-3 and 901-4, which may be operatively coupled via one or more networks 909, which may include wired and/or wireless networks.

As an example, a system can include an individual computer system or an arrangement of distributed computer systems. In the example of FIG. 9, the computer system 901-1 can include one or more modules 902, which may be or include processor-executable instructions, for example, executable to perform various tasks (e.g., receiving information, requesting information, processing information, simulation, outputting information, etc.).

As an example, a module may be executed independently, or in coordination with, one or more processors 904, which is (or are) operatively coupled to one or more storage media 906 (e.g., via wire, wirelessly, etc.). As an example, one or more of the one or more processors 904 can be operatively coupled to at least one of one or more network interfaces 907; noting that one or more other components 908 may also be included. In such an example, the computer system 901-1 can transmit and/or receive information, for example, via the one or more networks 909 (e.g., consider one or more of the Internet, a private network, a cellular network, a satellite network, etc.).

As an example, the computer system 901-1 may receive from and/or transmit information to one or more other devices, which may be or include, for example, one or more of the computer systems 901-2, etc. A device may be located in a physical location that differs from that of the computer system 901-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 906 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution. As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving real-time data from field equipment at a field site;
responsive to receipt of the real-time data, dynamically generating instructions for a user interface for field operations at the field site;
transmitting the instructions via a network to a display device for rendering of the user interface to a display of the display device;
receiving interaction data responsive to interactions with the display device;
responsive to receipt one or more of the interaction data and additional real-time data from the field equipment, dynamically generating revised instructions for a revised user interface for field operations at the field site; and
transmitting the revised instructions via the network to the display device for rendering of the revised user interface to the display of the display device.

2. The method of claim 1, wherein the dynamically generating the instructions comprises detecting a number of events based on the real-time data.

3. The method of claim 2, comprising classifying the number of events into classes.

4. The method of claim 3, wherein the classes comprise an emergency class, a normal operational class, and a maintenance class.

5. The method of claim 1, wherein the dynamically generating the instructions comprises executing a machine learning model.

6. The method of claim 5, wherein the machine learning model comprises a large language model.

7. The method of claim 1, wherein a graphical user interface comprises a chat graphical control wherein interactions with the chat graphical control generate at least a portion of the interaction data.

8. The method of claim 7, wherein the interactions with the chat graphical control cause a large language model to generate output, wherein the dynamically generating the revised instructions for the revised user interface utilizes at least a portion of the output.

9. The method of claim 1, wherein the dynamically generating the instructions for the user interface comprises accessing a template database and selecting a template from the template database.

10. The method of claim 1, wherein the dynamically generating the instructions for the user interface comprises accessing a visual elements database and selecting one or more of the visual elements from the visual elements database.

11. The method of claim 1, wherein the revised user interface comprises a larger text font size than the user interface.

12. The method of claim 1, wherein the revised user interface comprises a different font color than the user interface.

13. The method of claim 1, comprising receiving user sensor data from one or more user sensors, wherein the dynamically generating the revised instructions depends on at least a portion of the user sensor data.

14. The method of claim 13, wherein the one or more user sensors comprise one or more of a heart rate sensor, an infrared sensor, and a video camera sensor.

15. The method of claim 1, wherein the field site is an oil and gas industry site.

16. The method of claim 1, wherein the field site is a carbon sequestration industry site.

17. The method of claim 1, comprising identifying a user of the user interface and accessing a user preferences database for user preference data for the user, wherein the dynamically generating the instructions generates the instructions based at least in part on the user preference data.

18. The method of claim 1, comprising identifying a geographical location of the display device, wherein the dynamically generating the instructions generates the instructions based at least in part on a geographical location of the user.

19. A system comprising:
a processor;
a memory operatively coupled to the processor; and
processor-executable instructions stored in the memory and executable to instruct the system to:
receive real-time data from field equipment at a field site;
responsive to receipt of the real-time data, dynamically generate instructions for a user interface for field operations at the field site;
transmit the instructions via a network to a display device for rendering of the user interface to a display of the display device;
receive interaction data responsive to interactions with the display device;
responsive to receipt one or more of the interaction data and additional real-time data from the field equipment, dynamically generate revised instructions for a revised user interface for field operations at the field site; and
transmit the revised instructions via the network to the display device for rendering of the revised user interface to the display of the display device.

20. One or more computer-readable storage media comprising processor-executable instructions executable by a system to instruct the system to:
receive real-time data from field equipment at a field site;
responsive to receipt of the real-time data, dynamically generate instructions for a user interface for field operations at the field site;
transmit the instructions via a network to a display device for rendering of the user interface to a display of the display device;
receive interaction data responsive to interactions with the display device;
responsive to receipt one or more of the interaction data and additional real-time data from the field equipment, dynamically generate revised instructions for a revised user interface for field operations at the field site; and
transmit the revised instructions via the network to the display device for rendering of the revised user interface to the display of the display device.
